(19) United States
(12) Patent Application Publication
(10) Pub. No.: US 2016/0255135 A1
(43) Pub. Date: Sep. 1, 2016

(54) METHOD AND APPARATUS FOR DISPLAYING PROCESSING STATUS

(71) Applicant: TENCENT TECHNOLOGY (SHENZHEN) COMPANY LIMITED, Shenzhen, Guangdong (CN)

(72) Inventor: Dong XIE, Shenzhen (CN)

(73) Assignee: TENCENT TECHNOLOGY (SHENZHEN) COMPANY LIMITED, Shenzhen, Guangdong (CN)

(21) Appl. No.: 15/031,827

(22) PCT Filed: Oct. 10, 2014
(86) PCT No.: PCT/CN2014/088261

§ 371 Date: Apr. 25, 2016

(30) Foreign Application Priority Data
Oct. 25, 2013 (CN) 201310514562.3

(51) Int. Cl. H04L 29/08; G06F 3/0484; G06Q 30/02; H04L 12/58

(52) U.S. Cl. CPC H04L 67/06; H04L 51/10; H04L 51/046; G06F 3/04847; G06Q 30/0267

(57) ABSTRACT

The present invention discloses a method for displaying a processing status, which includes: obtaining, by a terminal device, a target window and a target control corresponding to a target window when detecting a data processing event; obtaining, by the terminal device, a data type corresponding to the data processing event through the target control; obtaining, by the terminal device, configuration corresponding to the target control; obtaining a material image corresponding to the data type from the configuration, and displaying, by the terminal device, the material image in the target window to indicate the processing status. Furthermore, the present invention discloses an apparatus for displaying a processing status. Thus, operation convenience can be improved.

### FIELD OF THE TECHNOLOGY

The present disclosure relates to an internet technology field, and more particularly, to a method and apparatus for displaying a processing status.

### BACKGROUND OF THE DISCLOSURE

At present, when data is loaded or transmitted through available network resource, a processing status will be displayed to indicate that a computer is performing data downloading from a network, and does not crash. For example, when the data is downloading, prompt information “loading . . . ” is displayed, and especially, three points behind “load” is circularly displayed. In another example, a rolling gif image is displayed. After the processing finishes, the processing status will be removed.

### SUMMARY OF THE DISCLOSURE

A method for displaying a processing status is provided according to an embodiment of the present invention, so as to improve operation convenience.

A method for displaying a processing status includes:

obtaining, by a terminal device, a target window and a target control corresponding to a target window when detecting a data processing event;

obtaining, by the terminal device, a data type corresponding to the data processing event through the target control;

obtaining, by the terminal device, configuration corresponding to the target control;

obtaining a material image corresponding to the data type from the configuration, and

displaying, by the terminal device, the material image in the target window to indicate the processing status.

Furthermore, an apparatus for displaying a processing status is provided according to an embodiment of the present invention, so as to improve operation convenience.

An apparatus for displaying a processing status includes:

a control obtaining module, to obtain a target window and a target control corresponding to a target window when detecting a data processing event;

a data type obtaining module, to obtain a data type corresponding to the data processing event through the target control;

a material image obtaining module, to obtain configuration corresponding to the target control, obtain a material image corresponding to the data type from the configuration; and

a status displaying module, to display the material image in the target window to indicate the processing status.

It can be seen from the above that, for data with different data types, processing status information is displayed through a material image in a control window, so that a user can know the data type of the data before obtaining a processing result of the data, and the processing can be conveniently continued or cancelled by the user in a processing process. Thus, time of the user is saved and operation convenience is improved.

When accessing to a network, the user can determine whether amount of data to be downloaded is large according to a material image. Thus, a downloading process can be cancelled in time to save flow. When chatting with friends, the user can determine a social relationship between the user and an information transmitter (e.g., belonging to different social groups) according to a material image. Thus, it is not needed to search for personal data of the user and operation convenience is improved.

### BRIEF DESCRIPTION OF DRAWINGS

FIG. 1 is a flowchart illustrating a method for displaying a processing status according to an embodiment of the present invention;

FIG. 2 is a schematic diagram illustrating an interface of configuring a material image according to an embodiment of the present invention;

FIG. 3 is a schematic diagram illustrating an interface of displaying a material image and a processing result according to an embodiment of the present invention;

FIG. 4 is a schematic diagram illustrating an interface of displaying processing progress information according to an embodiment of the present invention;

FIG. 5 is another schematic diagram illustrating an interface of displaying processing progress information according to an embodiment of the present invention;

FIG. 6 is a schematic diagram illustrating an interface of adjusting a location of a result displaying area according to processing progress information according to an embodiment of the present invention;

FIG. 7 is another schematic diagram illustrating an interface of adjusting a location of a result displaying area according to processing progress information according to an embodiment of the present invention;

FIG. 8 is a schematic diagram illustrating an interface of adjusting a size of a result displaying area according to processing progress information according to an embodiment of the present invention;

FIG. 9 is a schematic diagram illustrating an interface of changing a material image according to according to processing progress information according to an embodiment of the present invention;

FIG. 10 is a schematic diagram illustrating an interface of displaying advertisement information according to an embodiment of the present invention;

FIG. 11 is a schematic diagram illustrating an interface of displaying processing speed information according to an embodiment of the present invention;

FIG. 12 is a schematic diagram illustrating an interface of changing a material image according to processing speed according to an embodiment of the present invention;

FIG. 13 is a schematic diagram illustrating an interface of displaying data amount information according to an embodiment of the present invention;

FIG. 14 is a schematic diagram illustrating a structure of an apparatus for displaying a processing status according to an embodiment of the present invention;

FIG. 15 is another schematic diagram illustrating a structure of an apparatus for displaying a processing status according to an embodiment of the present invention;

FIG. 16 is a schematic diagram illustrating a structure of a computing device according to an embodiment of the present invention.

### DETAILED DESCRIPTION OF THE DISCLOSURE

In order to make the object, technical solution and merits of the present invention clearer, the present invention will be illustrated in detail hereinafter with reference to the accompanying drawings and specific examples. Obviously, the described embodiments are only partial embodiments of the present invention, but are not all embodiments. The present invention may be represented as different forms, and thus is not limited to the described embodiments.

Unless there is a specific and clear description, for elements and components in the present invention, the elements and the components can exist in a single form or in a plurality form, which is not be limited in the present invention. Although steps in the present invention are ranked by use of reference numbers, the reference numbers cannot limit an order of the steps. Unless it is specifically described that there is an order among the procedures or a certain procedure is based on another procedure, orders of the steps can be adjusted. As used herein, the term “and/or” means include any one or all of possible combinations of at least one enumerated items.

Applicants find that there are the following problems in current technical solutions: content of the processing status displayed is configured by developers, and is usually not changed for different conditions. In a downloading process, since a processing result is unknown, users cannot obtain information about downloaded content, such as a type of the downloaded content (e.g., text, audio or image). The users will obtain the information of the downloaded content until the processing result is completely displayed after the processing finishes. Thus, the operation is not convenient.

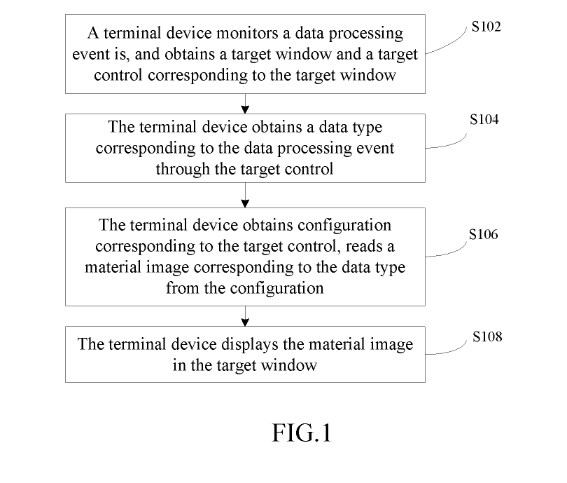

FIG. 1 is a flowchart illustrating a method for displaying a processing status. As shown in FIG. 1, the method includes procedures as follows.

The method may be implemented by such as a terminal device. The terminal device may be a mobile terminal such as a mobile phone, a smartphone, a notebook computer, a tablet PC and so on. In addition, the terminal device may also be a mobile terminal not moved such as a desktop computer and so on.

The method for displaying a processing status includes procedures as follows.

At block S102, a terminal device detects a data processing event is, and obtains a target window and a target control corresponding to the target window.

The data processing event may include a data uploading/downloading event, a data compression/decompression event, a program installing/uninstalling event, or a batch instruction executing event etc. For example, after connecting with a server, the terminal device may trigger the data download event when starting downloading data. When starting uploading data to the server, the data uploading event is triggered. When receiving an instruction inputted by the user, the terminal device starts perform file compression for data to trigger the data compression event.

The target control may include a control configured to process data and generate a processing result. The target control may include a target window for displaying a processing progress and a processing result. The target control may further include an event responding function to respond the data processing event. A process of processing the data is performed according to the triggered data processing event. For example, a data communication control may response the triggered data downloading event and the triggered data uploading event, so as to perform a process of downloading data and uploading data.

For example, in an application scenario, when chatting with a friend through an instant messaging client, a user transmits a picture to a friend by click a button for transmitting a picture and selecting the picture in a chatting window (which is taken as the target window corresponding to a data communication control of the target control). A picture transmitting event (a type of data processing event) is triggered through the operation that the user transmits the picture. Since the picture transmitting event is triggered by the operation of the user in the chatting window, the chatting window may be the target window corresponding to the picture transmitting event. The data communication control of a terminal device of a friend of the user may be the target control corresponding to the picture transmitting event, wherein the picture data is transmitted to the terminal device of the friend.

At block S104, the terminal device obtains a data type corresponding to the data processing event through the target control.

In an example, the data type may include text, audio, image, video etc. In another example, the data type may be obtained according to a file extension.

In an example, the chatting window supports a drag function. When the user drags a file with an extension “jpg” and releases a pointing device (e.g., a mouse), the inputted file with the file extension “jpg” is transmitted to terminal device of the friend. The data communication control obtains the file extension “jpg” of the inputted file, and obtains that the data type of the transmitted data is “image” in the data processing event.

In another example, the data type may correspond to a type of the target window. For example, in an instant messaging scenario, when the user has five friends in a chatting application, the data types of message data in various chatting windows (target windows) respectively corresponding to various friends are same with each other. Alternatively, the data types of the message data may respectively correspond to user identifiers of the friends. When the user has three groups in the chatting application, data types of the message data in chatting windows (target windows) corresponding to various groups are same with each other, or respectively correspond to group identifiers of the groups.

At block S106, the terminal device obtains configuration information corresponding to the target control, reads a material image corresponding to the data type from the configuration information.

The material image may include a dynamic image, e.g., a dynamic image with a format gif. In an example, the configuration information corresponding to the target control may be stored in a form of a configuration file. The user may perform configuration by writing the configuration file through an input instruction. The process may include procedures as follows.

The terminal device receives a material configuration instruction, obtains the material image corresponding to the material configuration, and establishes a relationship between the material image and preset data type information.

In an example, the material configuration instruction may include the data type information. The may obtain the material image corresponding to the data type in the material configuration.

In particular, the user may select the material image in a local memory, may input the material configuration instruction for selected preset data type information. An address of the material image may be obtained, and may establish a relationship between the address and the data type information in the configuration file.

For example, when the user wants to configure a gif image of a rolling ball for the processed data with a text type, the user may write an address of the gif image into a location corresponding to the text type in the configuration file by inputting a material configuration instruction. When the user wants to configure a gif image of a rotating windmill for the processed data with an image type, the user may write an address of the gif image into a location corresponding to the text type by inputting a material configuration instruction.

At block S108, the terminal device displays the material image in the target window.

In an example, the terminal device may detect whether the data processing event corresponding to the target control finishes. When it is detected that the data processing event finishes, the material image is removed from the target window and display a processing result.

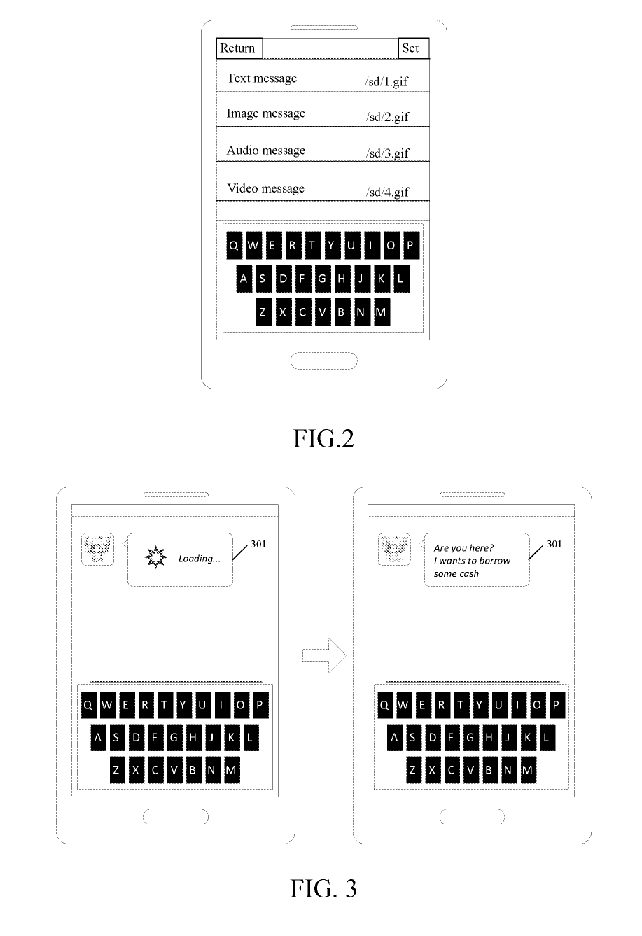

As shown in FIG. 2, the user may select the material image from multiple images stored in the local memory, wherein the material image may be used to indicate a downloading status of a chatting message with a text type, an image type or an audio type.

For example, as shown in FIG. 2, the user selects an image 1.gif as the material image for a text message, selects an image 2.gif as the as the material image for an image message, selects an image 3.gif as the material image for an audio message, selects an image 4.gif as the as the material image for a video message.

As shown in FIG. 3, in a chatting window, when a process of downloading the chatting message finishes, the material image may be removed, the chatting message is displayed in the chatting window.

For example, as shown in FIG. 3, in the process of downloading the chatting message, the material image is displayed in a message box 301 of the chatting window (i.e., the target window). When the process of downloading the chatting message finishes, the material image may be removed, the chatting message “Are you here? I want to borrow some cash” is displayed in the message box 301 of the chatting window.

In an example, after obtaining the target control corresponding to the data processing event, the terminal device may obtain processing progress information corresponding to the data processing event.

Furthermore, after obtaining the processing progress information corresponding to the data processing event, the processing progress information may be displayed in the target window.

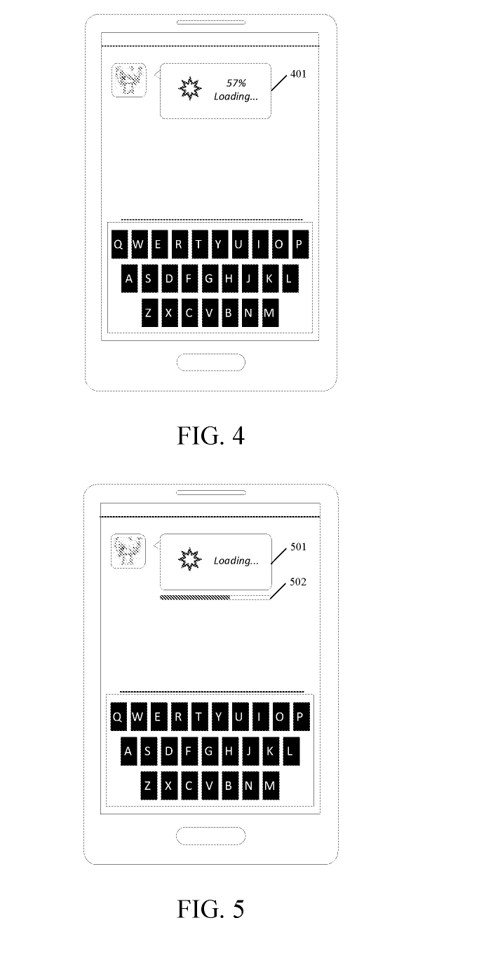

The processing progress information may be progress information indicating a percentage of data processed by the target control. The processing progress information may include downloading progress information, uploading progress information, compression progress information, or decompression progress information etc. In an example, as shown in FIG. 4, the downloading progress information (e.g., 57% in FIG. 4) may be dynamically displayed in a percentage form in a message box 401 of the chatting window. In another example, as shown in FIG. 5, the processing progress information may be displayed in a form of a progress bar 502 under a message box 501 of the chatting window.

Furthermore, there is a result displaying area in the target window. The process of displaying the processing result in the target window may include displaying the processing result in a result displaying area in the target window.

In an example, the result displaying area may be the message box in the chatting window.

In an example, as shown in FIG. 3, in a chatting application, the material image may be directly displayed in the result displaying area 301 (called as a chatting bubble in an example). When downloading the chatting message finishes, the chatting message downloaded from a server may be directly displayed in the result displaying area.

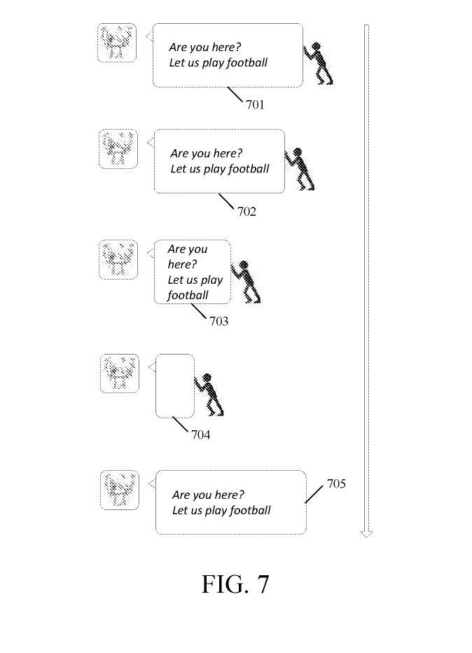

In another example, as shown in FIG. 7, the material images may be respectively displayed near the message boxes 701-704.

In an example, after obtaining the processing progress information corresponding to the data processing event through the target control, the method may further include adjusting a size, a background color and/or a location of the result displaying area.

In an example, when the processing progress information reaches a preset threshold, e.g., 50%, the background color is changed from green to red.

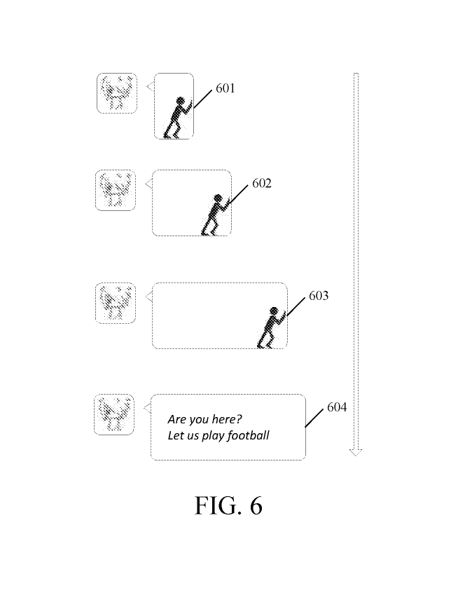

FIG. 6 is a schematic diagram illustrating an interface of displaying a status of receiving a chatting message according to an embodiment of the present invention. The processing progress information may include downloading progress of downloading a chatting message. In a chatting window, some message boxes may be displayed in sequence from a smallest size to a biggest size. The message boxes may respectively include a material image, e.g., a person pushing a box as shown in FIG. 6. A size of the message box in which the material image is displayed may represent the downloading progress of downloading the chatting message. When the process of downloading the chatting message finishes, the chatting message is displayed in a latest message box. For example, in FIG. 6, at first, when the downloading progress of downloading the chatting message is 25%, the message box 601 in which the material image, i.e., a person pushing a box, is displayed in the chatting window. Afterwards, when the downloading progress of downloading the chatting message is 50%, the message box 602 is displayed in the chatting window. When the downloading progress of downloading the chatting message is 75%, the message box 603 is displayed in the chatting window. When the downloading progress of downloading the chatting message is 100%, that is, the process of downloading the chatting message finished, the chatting message is displayed in the message box 604. At last, the message boxes 601-603 in which a material image with a gif type are displayed and the message box 604 in which the chatting message is displayed are displayed in the chatting window at the same time. Thus, an animation effect is represented that the person pushes in the result displaying area in which the downloaded chatting message is displayed.

FIG. 7 is a schematic diagram illustrating an interface of displaying a status of transmitting a chatting message according to an embodiment of the present invention. The processing progress information may include transmitting progress of transmitting a chatting message. In a chatting window, some message boxes may be displayed in sequence from a biggest size to a smallest size. The material images e.g., a person pushing a box as shown in FIG. 7 are respectively displayed near the message boxes. A size of the message box may represent the transmitting progress of downloading the chatting message. When the process of transmitting the chatting message finishes, the chatting message is displayed in a latest message box. For example, in FIG. 7, at first, when the transmitting progress of transmitting the chatting message is 25%, the message box 701 is displayed in the chatting window. Afterwards, when the transmitting progress of transmitting the chatting message is 50%, the message box 702 is displayed in the chatting window. When the transmitting progress of transmitting the chatting message is 75%, the message box 703 is displayed in the chatting window. When the transmitting progress of transmitting the chatting message is 100%, that is, the process of transmitting the chatting message finished, the chatting message is displayed in the message box 704. At last, the message boxes 701-704 respectively displayed near locations of material images with a gif type and the message box 705 in which the chatting message is displayed are displayed in the chatting window at the same time. Thus, an animation effect is represented that the person pushes out the result displaying area in which the transmitting chatting message is displayed.

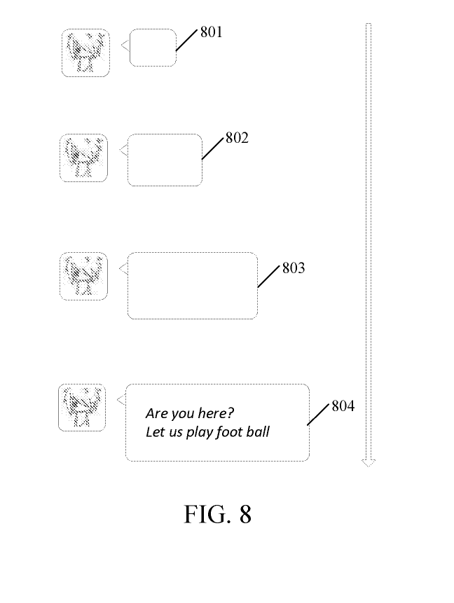

FIG. 8 is a schematic diagram illustrating an interface of displaying a status of receiving a chatting message according to an embodiment of the present invention. As shown in FIG. 8, with the increase of data amount of the chatting message being downloaded, the result displaying areas 801-804 are gradually enlarged.

In an example, after obtaining processing progress information corresponding to the data processing event through the target control, the material image may be changed according to the processing progress information.

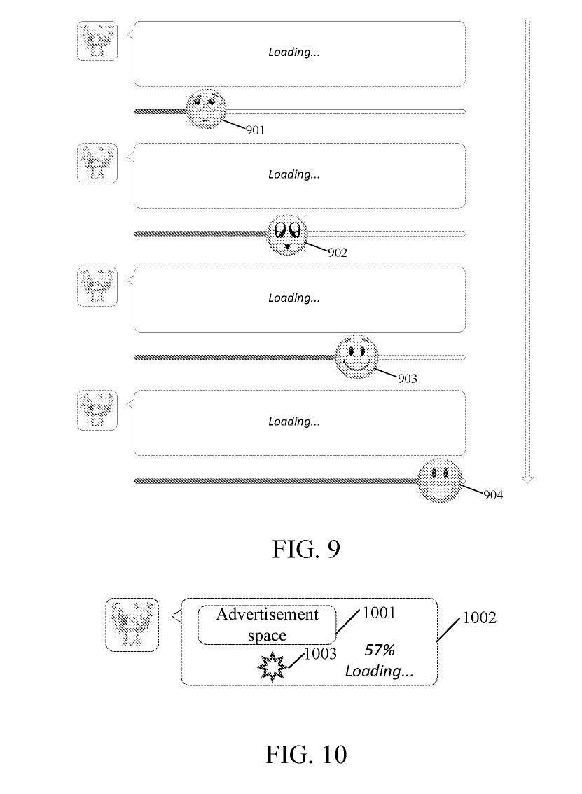

For example, as shown in FIG. 9, with the increase of the processing progress information, when the processing progress information reaches a preset threshold (e.g., a preset percentage), the material picture may be changed. In FIG. 9, the material picture may be configured on a progress bar, and may be changed with the moving of the progress bar. With the increase of the processing progress, the material picture may respectively be changed from a picture of a sad expression to a picture of a smile expression. When the processing progress information reaches a preset threshold 25%, the material picture in the progress bar is a picture of a sad expression 901. When the processing progress information reaches a preset threshold 50%, the material picture in the progress bar is a picture of an expectation expression 902. When the processing progress information reaches a preset threshold 75%, the material picture in the progress bar is a picture of a happy expression 903. When the processing progress information reaches a preset threshold 98%, the material picture in the progress bar is a picture of a smile expression 904. Thus, the user may be indicated that the process will end.

In an example, advertisement information may further be obtained, and displayed in a location corresponding to a material picture.

The advertisement information may read in local, or may be downloaded by an online advertiser. As shown in FIG. 10, the advertisement information is displayed in an advertisement space 1001. The advertisement space 1001 may be in a message box 1002 and near the material picture 1003. The advertisement information read in local or downloaded by the online advertiser is displayed in the advertisement space 1001.

In an example, after obtaining the target control corresponding to the data processing event, processing speed information corresponding to the data processing event may be obtained through the target control.

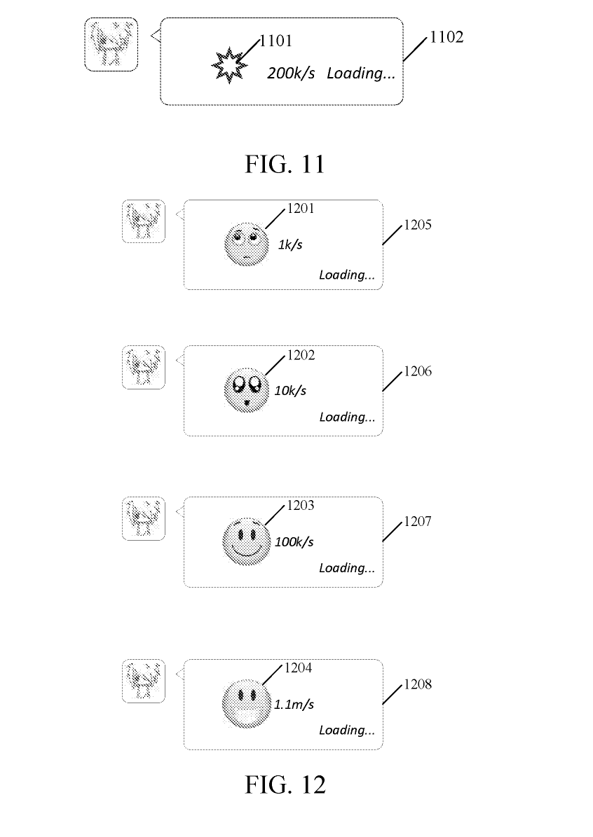

The processing speed information may include a data downloading speed, a data uploading speed, a compression speed, a decompression speed, a file transmission speed etc. The processing speed information may be obtained through the target control. In an example, as shown in FIG. 11, the processing speed information 200 k/s is displayed in a location in a message box 1102 and near a material picture 1101.

In an example, after obtaining processing speed information corresponding to the data processing event through the target control, the material picture may be changed according to the processing speed information.

In a scenario based on a chatting application, as shown in FIG. 12, a mood picture may be changed according to the processing speed. For example, when a network speed is slow e.g., 1 k/s, a material picture representing a sad expression 1201 is displayed in a message box 1205. When the network speed is 10 k/s, a material picture representing an expectation expression 1202 is displayed in a message box 1206. When the network speed is 100 k/s, a material picture representing a happy expression 1203 is displayed in a message box 1207. When a network speed is fast, e.g., 1.1 m/s, a material picture representing a happy expression 1204 is displayed in a message box 1206.

In an example, after obtaining the target control corresponding to the data processing event, data amount information of the target control corresponding to the data processing event is obtained through the target control, and the data amount information is displayed.

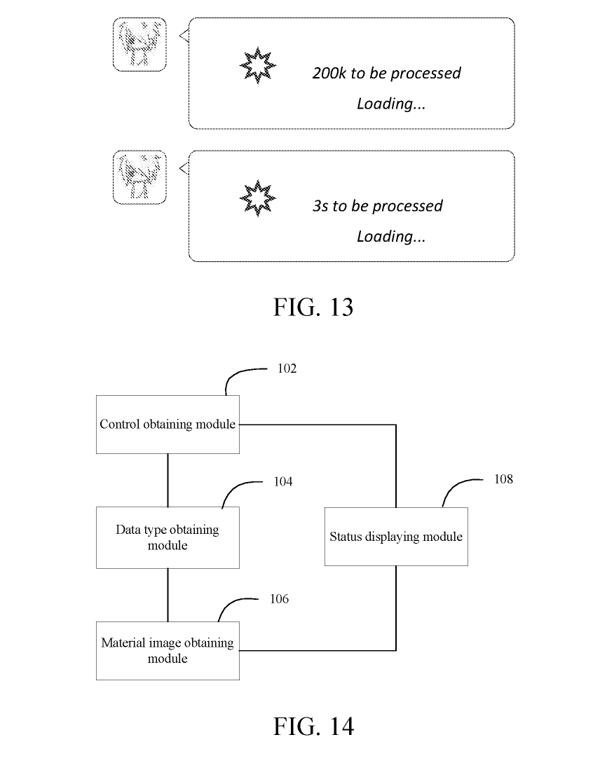

As shown in FIG. 13, the data amount information may be information of amount of data to be processed. The data amount information may be represented in a form of the number of additional bits, e.g., 200 k in FIG. 13, or may be represented in a form of additional processing time, e.g., 3 s in FIG. 13.

FIG. 14 is a schematic diagram illustrating a structure of an apparatus for displaying a processing status according to an embodiment of the present invention. As shown in FIG. 14, the apparatus 10 includes a control obtaining module 102, a data type obtaining module 104, a material image obtaining module 106 and a status displaying module 108.

The control obtaining module 102 is to obtain a target window and a target control corresponding to a target window when detecting the data processing event.

The data type obtaining module 104 is to obtain a data type corresponding to the data processing event through the target control.

The material image obtaining module 106 is to obtain configuration corresponding to the target control, obtain a material image corresponding to the data type from the configuration.

The status displaying module 108 is to display the material image in the target window to indicate the processing status.

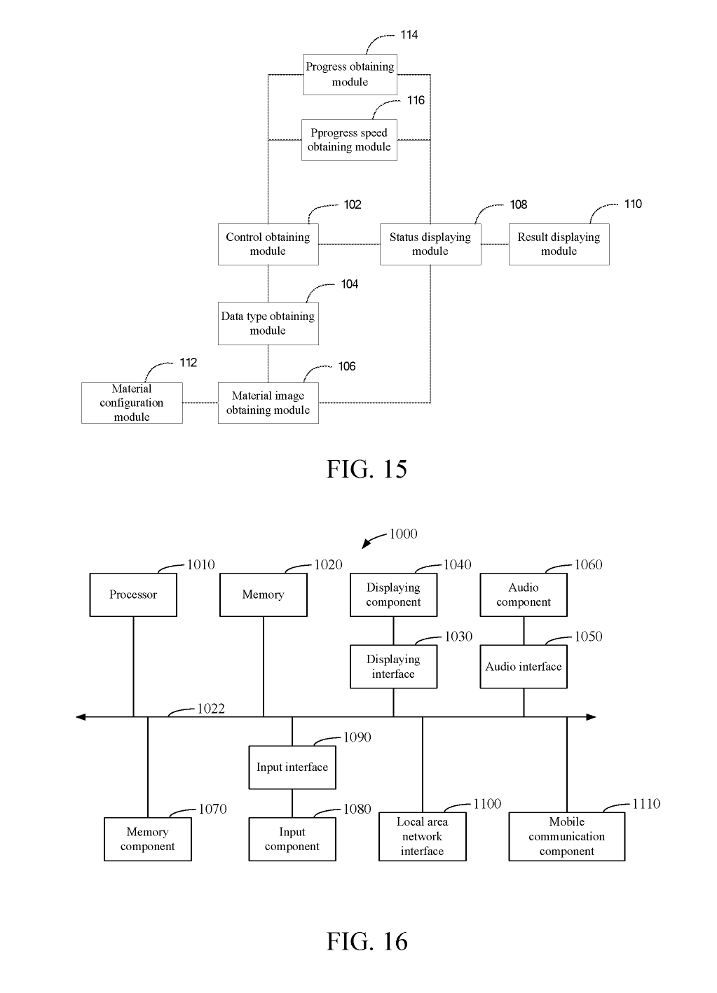

In an example, as shown in FIG. 15, the apparatus 10 further includes a result displaying module 110 to obtain a processing result when detecting that the data processing event corresponding to the target control finishes, removing the material image from the target window and display the processing result in the target window.

In an example, as shown in FIG. 15, the apparatus 10 further includes a material configuration module 112 to receive a material configuration instruction, obtain a material image corresponding to the material configuration instruction, establish a relationship between the material image corresponding to the material configuration and a preset data type information.

In an example, as shown in FIG. 15, the apparatus 10 further includes a progress obtaining module 114 to obtain processing progress information corresponding to the data processing event through the target control.

In an example, the status displaying module 108 is further to display the processing progress information in the target window.

In an example, there is a result displaying area in the target window.

The result displaying module 110 is to display the processing result in the result displaying area.

In an example, the status displaying module 108 is further to adjusting at least one of a size, a background color and a location of the result displaying area according to the processing progress information.

In an example, the status displaying module 108 is further to change the material image according to the processing progress information.

In an example, the status displaying module 108 is further to obtain advertisement information, display the advertisement information in a location corresponding to the material image.

In an example, as shown in FIG. 15, the apparatus 10 further includes a progress speed obtaining module 116 to obtain processing speed information corresponding to the data processing event through the target control.

In an example, the status displaying module 108 is further to change the material image corresponding to the processing speed information.

In an example, the status displaying module 108 is further to obtain data amount information corresponding to the data processing event through the target control, displaying the data amount information in the target window.

It can be seen from the above that, for data with different data types, processing status information is displayed through a material image in a control window, so that a user can know the data type of the data before obtaining a processing result of the data, and the processing can be conveniently continued or cancelled by the user in a processing process. Thus, time of the user is saved and operation convenience is improved.

When accessing to the internet, the user can determine whether amount of data to be downloaded is large according to a material image. Thus, a downloading process can be cancelled in time to save flow. When chatting with friends, the user can determine a social relationship between the user and an information transmitter (e.g., belonging to different social groups) according to a material image. Thus, it is not needed to search for personal data of the user and operation convenience is improved.

FIG. 16 is a schematic diagram illustrating a structure of a computer device according to an embodiment of the present invention. The computing device 1000 includes a processor 1010, a memory 1020. The computing device 1000 may further include a displaying component 1040, an audio component 1060, a displaying interface 1030, an audio interface 1050, an input interface 1090, a memory component 1070, an input component 1080, a local area network interface 1100, a mobile communication component 1110, and a system bus 1022.

The processor 1010 may execute instructions stored in the memory 1020. The instructions includes a control obtaining instruction, a data type obtaining instruction, a material image obtaining instruction and a status displaying instruction.

The control obtaining instruction is to obtain a target window and a target control corresponding to a target window when detecting the data processing event.

The data type obtaining instruction is to obtain a data type corresponding to the data processing event through the target control.

The material image obtaining instruction is to obtain configuration corresponding to the target control, obtain a material image corresponding to the data type from the configuration.

The status displaying instruction is to display the material image in the target window to indicate the processing status.

In an example, the instructions further include a result displaying instruction to obtain a processing result when detecting that the data processing event corresponding to the target control finishes, removing the material image from the target window and display the processing result in the target window.

In an example, the instructions further include a material configuration instruction to receive a material configuration instruction, obtain a material image corresponding to the material configuration instruction, establish a relationship between the material image corresponding to the material configuration and a preset data type information.

In an example, the instructions further include a progress obtaining instruction to obtain processing progress information corresponding to the data processing event through the target control.

In an example, the status displaying instruction is further to display the processing progress information in the target window.

In an example, there is a result displaying area in the target window.

The result displaying instruction is to display the processing result in the result displaying area.

In an example, the status displaying instruction is further to adjusting at least one of a size, a background color and a location of the result displaying area according to the processing progress information.

In an example, the status displaying instruction is further to change the material image according to the processing progress information.

In an example, the status displaying instruction is further to obtain advertisement information, display the advertisement information in a location corresponding to the material image.

In an example, as shown in FIG. 15, the instructions further include a progress speed obtaining instruction to obtain processing speed information corresponding to the data processing event through the target control.

In an example, the status displaying instruction is further to change the material image corresponding to the processing speed information.

In an example, the status displaying instruction is further to obtain data amount information corresponding to the data processing event through the target control, displaying the data amount information in the target window.

The foregoing is only preferred examples of the present invention and is not used to limit the protection scope of the present invention. Any modification, equivalent substitution and improvement without departing from the spirit and principle of the present invention are within the protection scope of the present invention.

1. A method for displaying a processing status, comprising:
obtaining, by a terminal device, a target window and a target control corresponding to the target window when detecting a data processing event;
obtaining, by the terminal device, a data type corresponding to the data processing event through the target control;
obtaining, by the terminal device, configuration corresponding to the target control;
obtaining a material image corresponding to the data type from the configuration, and
displaying, by the terminal device, the material image in the target window to indicate the processing status.

2. The method of claim 1, further comprising:
obtaining, by the terminal device, a processing result when detecting that the data processing event corresponding to the target control finishes;
removing, by the terminal device, the material image from the target window;
displaying, by the terminal device, the processing result in the target window.

3. The method of claim 1 or 2, further comprising:
receiving, by the terminal device, a material configuration instruction;
obtaining, by the terminal device, a material image corresponding to the material configuration instruction;
establishing, by the terminal device, a relationship between the material image corresponding to the material configuration and a preset data type information.

4. The method of claim 2, further comprising:
obtaining, by the terminal device, processing progress information corresponding to the data processing event through the target control after obtaining the data processing event corresponding to the target control.

5. The method of claim 4, further comprising:
displaying, by the terminal device, the processing progress information in the target window after obtaining the processing progress information corresponding to the data processing event through the target control.

6. The method of claim 4, wherein there is a result displaying area in the target window;
the processing of displaying the processing result comprising:
displaying, by the terminal device, the processing result in the result displaying area.

7. The method of claim 6, further comprising:
adjusting, by the terminal device, at least one of a size, a background color and a location of the result displaying area according to the processing progress information after obtaining the processing progress information corresponding to the data processing event through the target control.

8. The method of claim 4, further comprising:
changing, by the terminal device, the material image according to the processing progress information after obtaining the processing progress information corresponding to the data processing event through the target control.

9. The method of claim 1, further comprising:
obtaining, by the terminal device, advertisement information;
displaying, by the terminal device, the advertisement information in a location corresponding to the material image.

10. The method of claim 1, further comprising:
obtaining, by the terminal device, processing speed information corresponding to the data processing event through the target control after obtaining the target control corresponding to the data processing event.

11. The method of claim 10, further comprising:
changing, by the terminal device, the material image corresponding to the processing speed information after obtaining the processing speed information corresponding to the data processing event through the target control.

12. The method of claim 1, further comprising:
obtaining, by the terminal device, data amount information corresponding to the data processing event through the target control;
displaying, by the terminal device, the data amount information in the target window.

13. An apparatus for displaying a processing status, comprising:
a control obtaining module, to obtain a target window and a target control corresponding to the target window when detecting a data processing event;
a data type obtaining module, to obtain a data type corresponding to the data processing event through the target control;
a material image obtaining module, to obtain configuration corresponding to the target control, obtain a material image corresponding to the data type from the configuration; and
a status displaying module, to display the material image in the target window to indicate the processing status.

14. The apparatus of claim 13, further comprising:
a result displaying module, to obtain a processing result when detecting that the data processing event corresponding to the target control finishes, removing the material image from the target window and display the processing result in the target window.

15. The apparatus of claim 13, further comprising:
a material configuration module, to receive a material configuration instruction, obtain a material image corresponding to the material configuration instruction, establish a relationship between the material image corresponding to the material configuration and a preset data type information.

16. The apparatus of claim 14, further comprising:
a progress obtaining module, to obtain processing progress information corresponding to the data processing event through the target control.

17. The apparatus of claim 16, wherein the status displaying module is further to display the processing progress information in the target window.

18. (canceled)

19. (canceled)

20. (canceled)

21. The apparatus of claim 13, wherein the status displaying module is further to obtain advertisement information, display the advertisement information in a location corresponding to the material image.

22. The apparatus of claim 13, further comprising:
a progress speed obtaining module, to obtain processing speed information corresponding to the data processing event through the target control.

23. (canceled)

24. The apparatus of claim 13, wherein the status displaying module is further to obtain data amount information corresponding to the data processing event through the target control, displaying the data amount information in the target window.
